(19) United States
(12) Patent Application Publication
(10) Pub. No.: US 2018/0174164 A1
(43) Pub. Date: Jun. 21, 2018

(54) Predictive Analysis of Transactional Data

(71) Applicant: SAP SE, Walldorf (DE)

(72) Inventor: Pooja B, Bangalore (IN)

(21) Appl. No.: 15/383,516

(22) Filed: Dec. 19, 2016

(51) Int. Cl. G06Q 30/02; G06N 7/00; G06N 99/00

(52) U.S. Cl. CPC G06Q 30/0202; G06N 99/005; G06N 7/005

(57) ABSTRACT

Methods of predictive analysis of an attribute view of transactional data are disclosed. Methods are implemented by one or more data processors forming part of at least one computing device and include storing transactional data of an enterprise in a relational database residing in a memory of the at least one computing device, selecting a dataset from the transactional data, generating a first attribute view of the dataset, conducting a predictive analysis of the first attribute view, and providing data comprising the results of the predictive analysis. Related apparatus, systems, techniques and articles are also described.

### TECHNICAL FIELD

The subject matter described herein relates to computer-implemented methods and systems of using statistical approaches and other predictive analysis tools for analyzing transactional data and rendering results of such analysis. Such method and systems may involve computer analysis of transactional patterns to identify transactions conducted outside normal enterprise procurement processes or to identify groups of items purchased together to predict future trends.

### BACKGROUND

One of the common issues in procurement is purchasing goods (either materials or services) without following the standard purchasing processes adhered to in an organization. Such procurement transactions typically result in higher costs than purchases made under standard purchasing processes. It is desirable to reduce premium costs associated with transactions conducted outside the standard purchasing processes.

Another typical problem in procurement is difficulty in identifying a correlation between items purchased together. Without such identification, items with high profit margins and items with zero profit may be purchased together. It is desirable to reduce premium costs associated with such group purchases.

Conventional databases do not employ real time analytics to analyze trends in procurement. Existing solutions do not leverage the power of predictive analysis, available in an in-memory columnar database. Existing solutions typically involve a separate business intelligence (BI) system apart from the procurement landscape.

### SUMMARY

In a first aspect, a method of predictive analysis of an attribute view of transactional data may be implemented by one or more data processors forming part of at least one computing device and may include storing transactional data of an enterprise in a relational database residing in a memory of the at least one computing device, selecting a dataset from the transactional data, generating a first attribute view of the dataset, conducting a predictive analysis of the first attribute view, and providing data comprising the results of the predictive analysis.

Providing data can include at least one of: displaying the results of the predictive analysis in an electronic visual display, loading the results of the predictive analysis into memory, persisting the results of the predictive analysis into physical data storage, or transmitting the results of the predictive analysis to a remote computing system.

Transactional data can include purchase orders and contracts. Dataset can include transactions outside standard enterprise procurement processes. Providing data can include rendering information by year, where the information can include expenditures for the transactions outside standard enterprise procurement processes.

Conducting the predictive analysis of the first attribute view can include making a prediction about future transactions outside standard enterprise procurement processes. Transactions outside standard enterprise procurement processes can include transactions with vendors without procurement contracts. Methods can include negotiating procurement contracts with vendors predicted to have future transactions outside standard procurement processes.

Methods can include generating a second attribute view. Second attribute view can include net sales across suppliers for all items purchased against valid contracts. Dataset can include a group of procurement transactions representing procurement transactions made together. First attribute view can include a correlation between the procurement transactions in the group.

Dataset can include a purchase order table and a contracts table. Conducting predictive analysis can include creating a calculation view of the purchase order table and the contracts table, generating a signature table including input and output data types, passing the calculation view as input data to the signature table, calling an apriori algorithm from an application function library residing in the memory of the computing device, passing default statistical parameters to the apriori algorithm, generating a wrapper procedure by the apriori algorithm to derive rules of analysis, and using the rules of analysis to generate the results of the predictive analysis of the correlation.

Default statistical parameters can include a minimum support, a minimum confidence, and a minimum lift. Calculation view can include a profit margin of the procurement transactions in the group. Group can include transactions with no profit. Group can include transactions with profit margin above a pre-defined level. Pre-defined level can be 5% or more, 10% or more, 25% or more, or 50% or more.

Providing data can include rendering information for a lead item. Information can include at least one supplier of the lead item and a number of transactions for at least one consequent item for each of the at least one supplier for the lead item. Providing data can include rendering information by year. Information can include comprising an occurrence of at least two transactions made together.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. Since all the data is available in-memory as columnar data in modern in-memory relational database, using native artifacts in the database helps in efficiency as it effectively pushes down the business logic as much as possible into the database layer. The subject matter described herein effectively uses the native artifacts to initiate parallel processing for the basic calculations, data aggregations and analytical joins on the in-memory data to produce datasets. This helps in analyzing the source-to-contract scenario and spend analytics with real-time data and avoid an overhead of latency in the reported results. The report data can be plugged as a data source into various visualization tools for dynamic reporting and story board creation or into a Fiori application for standard reporting.

The subject matter described herein leverages the predictive analysis capabilities of an in-memory columnar database into an analytics application for procurement solution which helps avoid maverick buying and increase the efficiency of activities from sourcing to contract generation. This can be achieved using predictive analysis library (PAL) of in-memory relational database. The subject matter described herein minimizes risk, capitalizes on market trends and brings the benefits of the latest technologies like cloud and in-memory analytics into the existing procurement business cycle.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating an example database system for use in connection with the current subject matter;

FIG. 2 is a system diagram illustrating a distributed database system having a plurality of database instances;

FIG. 3 is a system diagram of an index server forming part of the database system of FIG. 1.

FIG. 4 is a system diagram illustrating a data flow for analyzing transactions outside standard enterprise procurement processes.

FIG. 5 is a system diagram illustrating a sequence diagram for positive trend analysis.

FIG. 6 is a system diagram illustrating a sequence diagram for negative trend analysis.

FIG. 7 is a chart illustrating lead suppliers and follow-on suppliers that exist for a particular item.

FIG. 8 is a chart illustrating support index, confidence index and average lift index.

FIG. 9 is a chart illustrating net sales across various suppliers.

FIG. 10 is a chart illustrating net sales across various suppliers for each item present.

FIG. 11 is a chart illustrating net sales per maverick item bought in a year.

FIG. 12 is a chart illustrating count of follow on items for a particular lead item segregated by lead suppliers.

FIG. 13 is a chart illustrating rate of occurrence of correlation among maverick items across years.

Like reference symbols in the various drawings indicate like elements.

### DETAILED DESCRIPTION

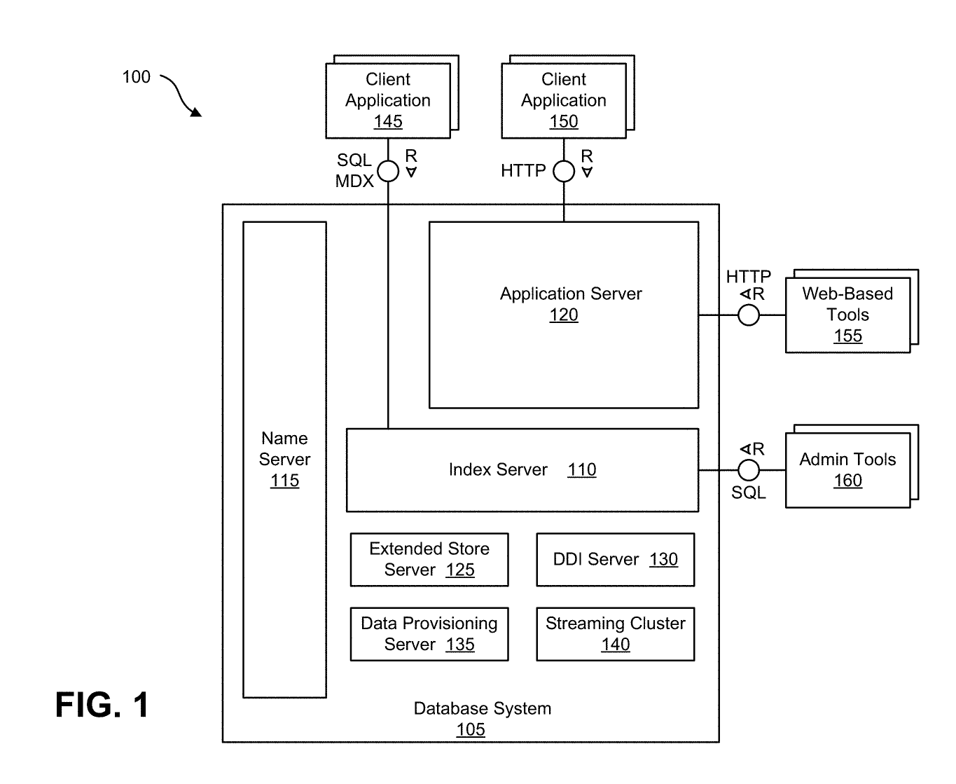

FIG. 1 is a diagram 100 illustrating a database system 105 that can be used to implement aspects of the current subject matter. The database system 105 can, for example, be an in-memory database in which all relevant data is kept in main memory so that read operations can be executed without disk I/O and in which disk storage is required to make any changes durables. The database system 105 can include a plurality of servers including, for example, one or more of an index server 110, a name server 115, and/or an application server 120. The database system 105 can also include one or more of an extended store server 125, a database deployment infrastructure (DDI) server 130, a data provisioning server 135, and/or a streaming cluster 140. The database system 105 can be accessed by a plurality of remote clients 145, 150 via different protocols such as SQL/MDX (by way of the index server 110) and/or web-based protocols such as HTTP (by way of the application server 120).

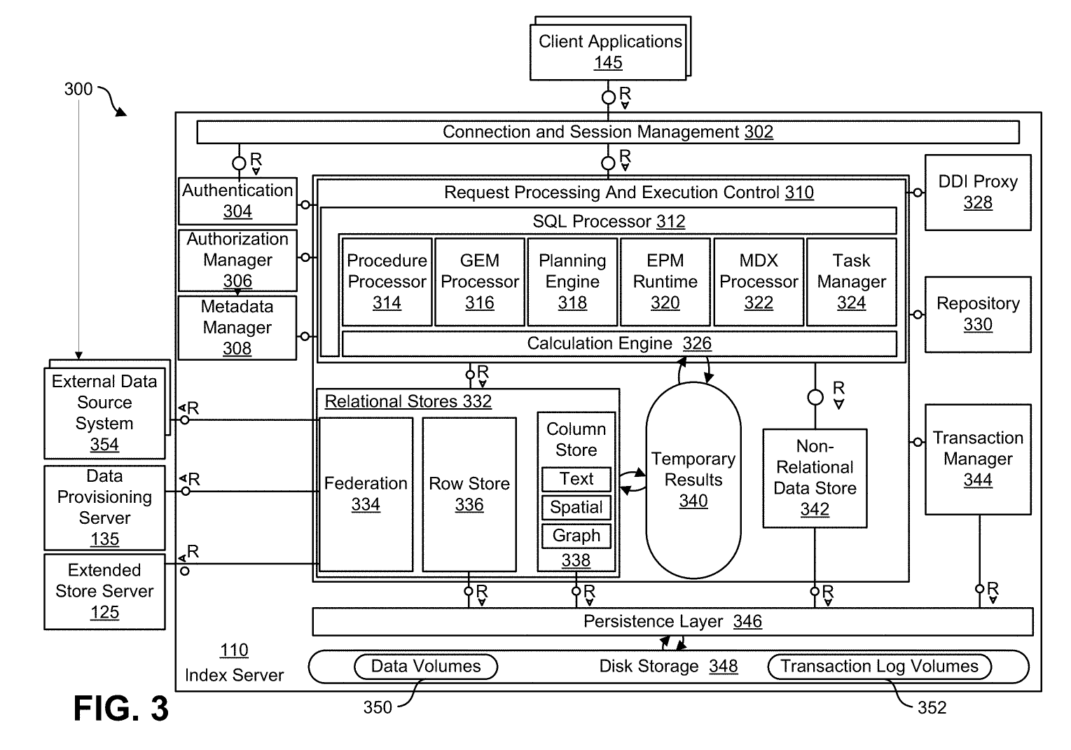

The index server 110 can contain in-memory data stores and engines for processing data. The index server 110 can also be accessed by remote tools (via, for example, SQL queries), that can provide various development environment and administration tools. Additional details regarding an example implementation of the index server 110 is described and illustrated in connection with diagram 300 of FIG. 3.

The name server 115 can own information about the topology of the database system 105. In a distributed database system, the name server 115 can know where various components are running and which data is located on which server. In a database system 105 with multiple database containers, the name server 115 can have information about existing database containers and it can also host the system database. For example, the name server 115 can manage the information about existing tenant databases. Unlike a name server 115 in a single-container system, the name server 115 in a database system 105 having multiple database containers does not store topology information such as the location of tables in a distributed database. In a multi-container database system 105 such database-level topology information can be stored as part of the catalogs of the tenant databases.

The application server 120 can enable native web applications used by one or more remote clients 150 accessing the database system 105 via a web protocol such as HTTP. The application server 120 can allow developers to write and run various database applications without the need to run an additional application server. The application server 120 can also be used to run web-based tools 155 for administration, life-cycle management and development. Other administration and development tools 160 can directly access the index server 110, for example, via SQL and other protocols.

The extended store server 125 can be part of a dynamic tiering option that can include a high-performance disk-based column store for very big data up to the petabyte range and beyond. Less frequently accessed data (for which it is non-optimal to maintain in main memory of the index server 110) can be put into the extended store server 125. The dynamic tiering of the extended store server 125 allows for hosting of very large databases with a reduced cost of ownership as compared to conventional arrangements.

The DDI server 130 can be a separate server process that is part of a database deployment infrastructure (DDI). The DDI can be a layer of the database system 105 that simplifies the deployment of database objects using declarative design time artifacts. DDI can ensure a consistent deployment, for example by guaranteeing that multiple objects are deployed in the right sequence based on dependencies, and by implementing a transactional all-or-nothing deployment.

The data provisioning server 135 can provide enterprise information management and enable capabilities such as data provisioning in real time and batch mode, real-time data transformations, data quality functions, adapters for various types of remote sources, and an adapter SDK for developing additional adapters.

The streaming cluster 140 allows for various types of data streams (i.e., data feeds, etc.) to be utilized by the database system 105. The streaming cluster 140 allows for both consumption of data streams and for complex event processing.

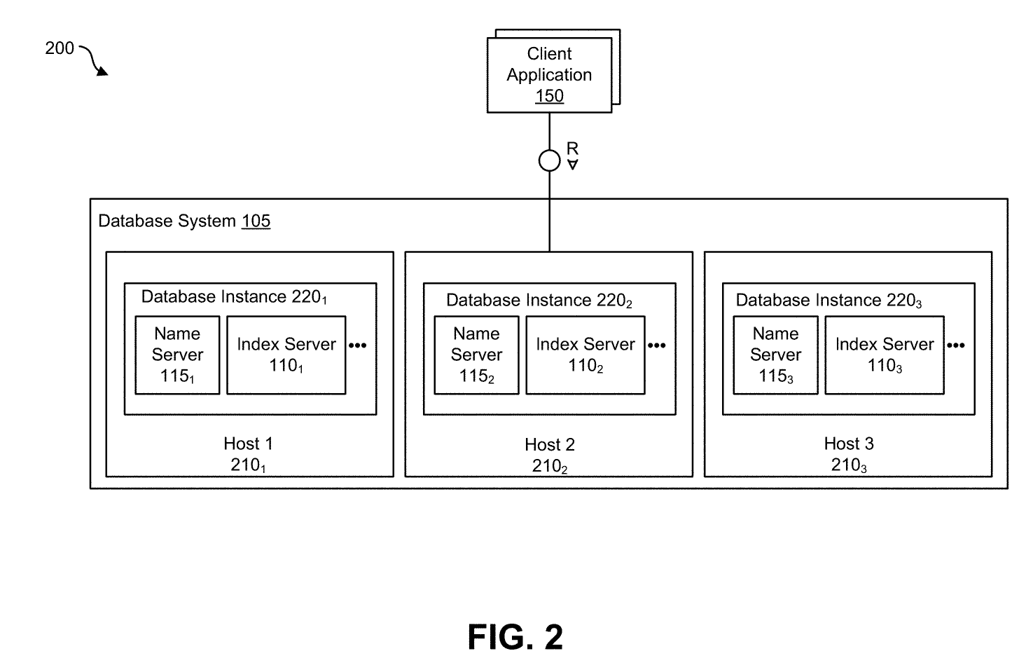

FIG. 2 is a diagram 200 illustrating a variation of the database system 105 that can support distribution of server components across multiple hosts for scalability and/or availability purposes. This database system 105 can, for example, be identified by a single system ID (SID) and it is perceived as one unit from the perspective of an administrator, who can install, update, start up, shut down, or backup the system as a whole. The different components of the database system 105 can share the same metadata, and requests from client applications 230 can be transparently dispatched to different servers 110₁₋₃, 120₁₋₃, in the system, if required.

As is illustrated in FIG. 2, the distributed database system 105 can be installed on more than one host 210₁₋₃. Each host 210₁₋₃ is a machine that can comprise at least one data processor (e.g., a CPU, etc.), memory, storage, a network interface, and an operation system and which executes part of the database system 105. Each host 210₁₋₃ can execute a database instance 220₁₋₃ which comprises the set of components of the distributed database system 105 that are installed on one host 210₁₋₃. FIG. 2 shows a distributed system with three hosts, which each run a name server 110₁₋₃, index server 120₁₋₃, and so on (other components are omitted to simplify the illustration).

FIG. 3 is a diagram 300 illustrating an architecture for the index server 110 (which can, as indicated above, be one of many instances). A connection and session management component 302 can create and manage sessions and connections for the client applications 145. For each session, a set of parameters can be maintained such as, for example, auto commit settings or the current transaction isolation level.

Requests from the client applications 145 can be processed and executed by way of a request processing and execution control component 310. The database system 105 offers rich programming capabilities for running application-specific calculations inside the database system. In addition to SQL, MDX, and WIPE, the database system 105 can provide different programming languages for different use cases. SQLScript can be used to write database procedures and user defined functions that can be used in SQL statements. The L language is an imperative language, which can be used to implement operator logic that can be called by SQLScript procedures and for writing user-defined functions.

Once a session is established, client applications 145 typically use SQL statements to communicate with the index server 110 which can be handled by a SQL processor 312 within the request processing and execution control component 310. Analytical applications can use the multidimensional query language MDX (MultiDimensional eXpressions) via an MDX processor 322. For graph data, applications can use GEM (Graph Query and Manipulation) via a GEM processor 316, a graph query and manipulation language. SQL statements and MDX queries can be sent over the same connection with the client application 145 using the same network communication protocol. GEM statements can be sent using a built-in SQL system procedure.

The index server 110 can include an authentication component 304 that can be invoked when a new connection with a client application 145 is established. Users can be authenticated either by the database system 105 itself (login with user and password) or authentication can be delegated to an external authentication provider. An authorization manager 306 can be invoked by other components of the database system 145 to check whether the user has the required privileges to execute the requested operations.

Each statement can be processed in the context of a transaction. New sessions can be implicitly assigned to a new transaction. The index server 110 can include a transaction manager 344 that coordinates transactions, controls transactional isolation, and keeps track of running and closed transactions. When a transaction is committed or rolled back, the transaction manager 344 can inform the involved engines about this event so they can execute necessary actions. The transaction manager 344 can provide various types of concurrency control and it can cooperate with a persistence layer 346 to achieve atomic and durable transactions.

Incoming SQL requests from the client applications 145 can be received by the SQL processor 312. Data manipulation statements can be executed by the SQL processor 312 itself. Other types of requests can be delegated to the respective components. Data definition statements can be dispatched to a metadata manager 306, transaction control statements can be forwarded to the transaction manager 344, planning commands can be routed to a planning engine 318, and task related commands can be forwarded to a task manager 324 (which can be part of a larger task framework). Incoming MDX requests can be delegated to the MDX processor 322. Procedure calls can be forwarded to the procedure processor 314, which further dispatches the calls, for example to a calculation engine 326, the GEM processor 316, a repository 300, or a DDI proxy 328.

The index server 110 can also include a planning engine 318 that allows planning applications, for instance for financial planning, to execute basic planning operations in the database layer. One such basic operation is to create a new version of a data set as a copy of an existing one while applying filters and transformations. For example, planning data for a new year can be created as a copy of the data from the previous year. Another example for a planning operation is the disaggregation operation that distributes target values from higher to lower aggregation levels based on a distribution function.

The SQL processor 312 can include an enterprise performance management (EPM) runtime component 320 that can form part of a larger platform providing an infrastructure for developing and running enterprise performance management applications on the database system 105. While the planning engine 318 can provide basic planning operations, the EPM platform provides a foundation for complete planning applications, based on application-specific planning models managed in the database system 105.

The calculation engine 326 can provide a common infrastructure that implements various features such as SQLScript, MDX, GEM, tasks, and planning operations. The SQLScript processor 312, the MDX processor 322, the planning engine 318, the task manager 324, and the GEM processor 316 can translate the different programming languages, query languages, and models into a common representation that is optimized and executed by the calculation engine 326. The calculation engine 326 can implement those features using temporary results 340 which can be based, in part, on data within the relational stores 332.

Metadata can be accessed via the metadata manager component 308. Metadata, in this context, can comprise a variety of objects, such as definitions of relational tables, columns, views, indexes and procedures. Metadata of all these types can be stored in one common database catalog for all stores. The database catalog can be stored in tables in a row store 336 forming part of a group of relational stores 332. Other aspects of the database system 105 including, for example, support and multi-version concurrency control can also be used for metadata management. In distributed systems, central metadata is shared across servers and the metadata manager 308 can coordinate or otherwise manage such sharing.

The relational stores 332 form the different data management components of the index server 110 and these relational stores can, for example, store data in main memory. The row store 336, a column store 338, and a federation component 334 are all relational data stores which can provide access to data organized in relational tables. The column store 338 can store relational tables column-wise (i.e., in a column-oriented fashion, etc.). The column store 338 can also comprise text search and analysis capabilities, support for spatial data, and operators and storage for graph-structured data. With regard to graph-structured data, from an application viewpoint, the column store 338 could be viewed as a non-relational and schema-flexible in-memory data store for graph-structured data. However, technically such a graph store is not a separate physical data store. Instead it is built using the column store 338, which can have a dedicated graph API.

The row store 336 can store relational tables row-wise. When a table is created, the creator can specify whether it should be row or column-based. Tables can be migrated between the two storage formats. While certain SQL extensions are only available for one kind of table (such as the “merge” command for column tables), standard SQL can be used on all tables. The index server 110 also provides functionality to combine both kinds of tables in one statement (join, sub query, union).

The federation component 334 can be viewed as a virtual relational data store. The federation component 334 can provide access to remote data in external data source system(s) 354 through virtual tables, which can be used in SQL queries in a fashion similar to normal tables.

The database system 105 can include an integration of a non-relational data store 342 into the index server 110. For example, the non-relational data store 342 can have data represented as networks of C++ objects, which can be persisted to disk. The non-relational data store 342 can be used, for example, for optimization and planning tasks that operate on large networks of data objects, for example in supply chain management. Unlike the row store 336 and the column store 338, the non-relational data store 342 does not use relational tables; rather, objects can be directly stored in containers provided by the persistence layer 346. Fixed size entry containers can be used to store objects of one class. Persisted objects can be loaded via their persisted object IDs, which can also be used to persist references between objects. In addition, access via in-memory indexes is supported. In that case, the objects need to contain search keys. The in-memory search index is created on first access. The non-relational data store 342 can be integrated with the transaction manager 344 to extend transaction management with sub-transactions, and to also provide a different locking protocol and implementation of multi version concurrency control.

An extended store is another relational store that can be used or otherwise form part of the database system 105. The extended store can, for example, be a disk-based column store optimized for managing very big tables, which ones do not want to keep in memory (as with the relational stores 332). The extended store can run in an extended store server 125 separate from the index server 110. The index server 110 can use the federation component 334 to send SQL statements to the extended store server 125.

The persistence layer 346 is responsible for durability and atomicity of transactions. The persistence layer 346 can ensure that the database system 105 is restored to the most recent committed state after a restart and that transactions are either completely executed or completely undone. To achieve this goal in an efficient way, the persistence layer 346 can use a combination of write-ahead logs, shadow paging and savepoints. The persistence layer 346 can provide interfaces for writing and reading persisted data and it can also contain a logger component that manages a transaction log. Transaction log entries can be written explicitly by using a log interface or implicitly when using the virtual file abstraction.

The persistence layer 236 stores data in persistent disk storage 348 which, in turn, can include data volumes 350 and/or transaction log volumes 352 that can be organized in pages. Different page sizes can be supported, for example, between 4k and 16M. Data can be loaded from the disk storage 348 and stored to disk page wise. For read and write access, pages can be loaded into a page buffer in memory. The page buffer need not have a minimum or maximum size, rather, all free memory not used for other things can be used for the page buffer. If the memory is needed elsewhere, least recently used pages can be removed from the cache. If a modified page is chosen to be removed, the page first needs to be persisted to disk storage 348. While the pages and the page buffer are managed by the persistence layer 346, the in-memory stores (i.e., the relational stores 332) can access data within loaded pages.

SAP HANA is an example of a modern in-memory relational database management system which doubles up as a platform that could be deployed as an on premise appliance or on cloud. It makes optimum use of the hardware capabilities so as to increase application performance and facilitate the development of new scenarios and applications that were earlier not possible. Since all the data is in-memory, the disk I/O penalty could be avoided which hugely increases the performance.

SRM stands for Supplier Relationship Management. SAP SRM deals with the end-to-end solution for procurement process. It involves the creation of many business objects like shopping cart, purchase orders, contracts, bid and quotations, invoice etc. With the introduction of analytics into the procurement scenario, it is possible to target the procure-to-pay market, by streamlining the source-to-contract and spend analysis with real-time data.

It is desirable to capture the traction in market effectively using real-time analytics for procurement business applications. Insights into the spend analysis can help better negotiate the terms and conditions in contracts with various suppliers and heighten the visibility of supplier relationships and risks involved.

Modern in-memory relational database management systems, such as SAP HANA, have various capabilities including in-memory data processing, analytics capabilities, predictive analysis etc. It is possible to utilize these capabilities in an analytics application for procurement solution which can help avoid maverick buying and increase the efficiency of activities from sourcing to contract generation.

Since all the data is available in-memory as columnar data in modern in-memory relational database management systems, the key challenge is to minimize the data transfer to and from the database by pushing down the business logic as much as possible into the database layer. This can be done by initiating parallel processing for the basic calculations, data aggregations and analytical joins on the in-memory data to produce datasets.

These datasets can then be utilized to generate different visualizations to help better understand the data. With this analysis, it becomes possible to make better decisions by gaining insight into company-wide spend performance and to identify opportunities and potential for savings.

One approach is to use a spend analytics tool. This tool can provide a way to analyze the amount of maverick buying in a company with respect to a particular supplier. This vital data could help the strategists to negotiate suitable contract terms with suppliers. Such analysis can be conducted regularly and may cover a pre-defined length of time—for example, a year.

Another approach can integrate the predictive analytics capability of modern in-memory relational database management systems with a spend analytics tool. This mechanism can provide a way to predict the groups of items that are frequently bought together.

In this latter approach, further analysis can be conducted in two different ways. Groups of frequently purchased items can either indicate a positive trend or a negative trend. In one example, it may be possible to analyze the profit margin of a group of items bought together. It may also be possible to narrow down on items that bring in a pre-defined level of profit—for example, 25% or more profit. This significant information can help in strategic business decisions like product pricing and stocking of items which yield higher profit in the demand-supply chain. Another example is to analyze the group of items that are bought together frequently at a loss or ad hoc, without any contracts (for example, maverick buying). This data regarding the negative trend can help the stakeholders to make better decision on negotiating contracts, not only for single items, but for the entire sets of items in that particular group.

The purchasing decision made by a customer may consist of a series of steps. It may begin with articulation of customer's wants which then materializes into a decision to purchase the same. This purchase may terminate with the generation of suitable receipt or bill generation. This entire process constitutes a procurement lifecycle.

A simple procurement lifecycle may consist of various artifacts such as shopping cart, purchase order, bid, auction, contract, confirmation, invoice etc. These artifacts can be captured technically into business objects which then can be used to aid in easing the purchasing process. The business objects in this case (sourcing-to-contract scenario) may be shopping cart, purchase order and contract.

One of the common issues which may occur during procurement is maverick buying, i.e. purchasing of goods (either materials or services) without following a standard purchasing processes adhered to in an organization. Maverick buying, or ad hoc buying, may result in making purchases at a premium. Maverick buying may also be called wild purchase with respect to supply management. For example, a laptop may be procured from a vendor at manufacturer's retail price (MRP) rate without getting any discount on it. Instead, if there is an existing agreement with a vendor to provide the same laptop at a discounted price, considerable savings can be achieved, by making purchases against this vendor.

Predictive analytics refers to the process of extracting valuable information from existing data sets in order to determine patterns and predict future outcomes, trends etc. Predictive analytics does not tell what will happen in the future. It merely points to what may happen in future, provided the current trend continues for a longer period. An output of predictive analytics processes may be, for example, a correlation between different types of transactions, or estimates of a number of future transactions, or other insight into trends in enterprise management. This information can then be used to adjust enterprise processes to optimize predicted outcomes and bring them closer to desired performance levels.

Predictive analytics includes a diverse set of statistical techniques including machine learning, modeling, and data mining that analyze historical and current facts to make predictions about unknown events which may occur in future. The different kinds of algorithms that aid predictive analysis can be broadly grouped into categories including clustering, association, classification, regression, time series, pre processing, social network analysis, and statistics.

Association analysis techniques can use a number of statistical algorithms and data mining techniques. Association analysis may help uncover correlations, casual structures or hidden patterns among a set of objects. For example, association analysis can assist in understanding the purchasing trends, i.e. what products and/or services consumers would be inclined to purchase at the same time. This can assist in predicting their future behavior.

Apriori algorithm is one of such association analysis algorithms. Given a set of items, apriori algorithm attempts to find the least minimum number of item sets commonly occurring among the subsets. Bottom-up approach can be followed here. A process known as “candidate generation” may be first applied where frequently occurring items in a subset are extended one at a time. These groups of candidates may be tested against the transactional data set. This process may terminate when no further extensions to this item set is possible. Apriori algorithm can make use of “breadth first” search and a tree structure to count the number of items in an item set.

From item sets having length (k−1), apriori algorithm may generate a candidate item set of length (k). The next step may involve identifying sporadic patterns and effectively pruning these candidate items. Thus the resulting item set may contain only frequent item sets of length (k). After this step, the transactional database may be scanned to ascertain frequent item sets among the candidates available.

Apriori function of predictive analysis library (PAL) can make use of the columnar data storage feature of a modern in-memory relational database to analyze the transactional data. This apriori function can take in input parameters which act as placeholders to receive the input data on which the analysis is to take place. Apriori function may support the following values as output: support, confidence and lift index for each of the item; the rules generated from the entire data set; and predictive model markup language (PMML) model in XML format to help export the model data.

The rule (X⇒Y) is said to have support, (s), if and only if (s %) of transactional data in database D contain (X∪Y). Rules for which the value of (s) is greater than a user-defined support is said to have a minimum support.

The rule (X⇒Y) is said to have confidence, (c), if and only if (c %) of transactional data in database D that contain X also contain Y. Rules for which the value of (c) is greater than a user-defined confidence is said to have minimum confidence.

In simple terms, lift is defined as the ratio of target response divided by average response. Lift can provide a means to measure the performance of association rules at classifying or predicting a response over a random target model.

The following three different aspects represent implementation examples: development of a tool to help analyze the amount of maverick spending in a particular year; applying apriori algorithm to analyze the correlation among items that contribute to more than 25% profit; and applying apriori algorithm to analyze the correlation among items that contribute to zero/negative profit margin.

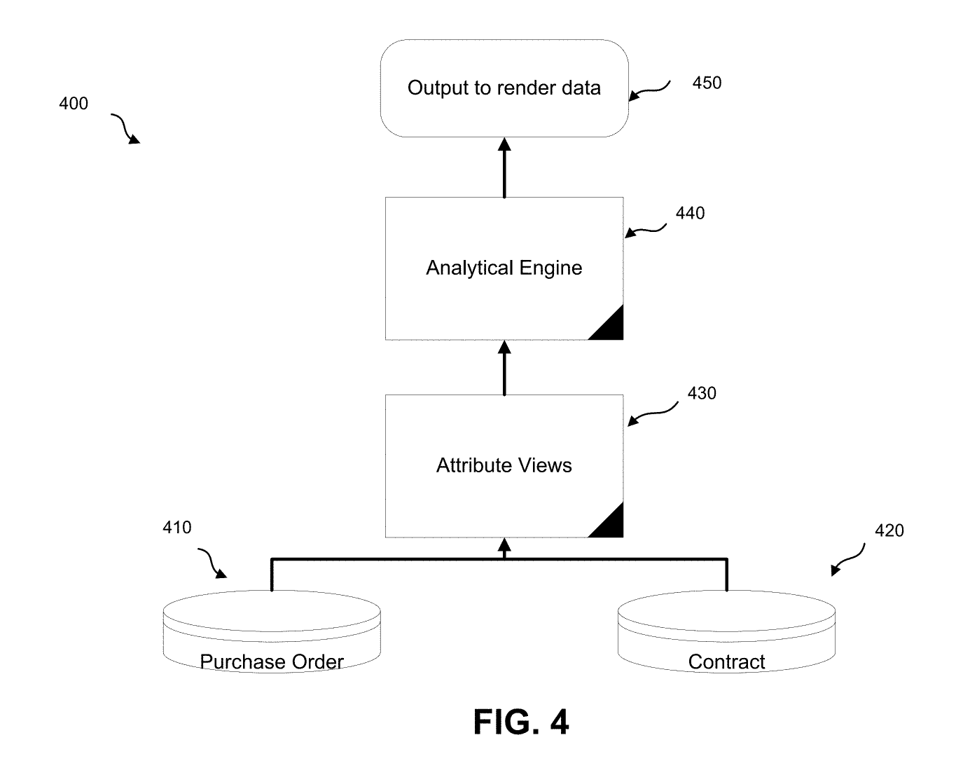

The first implementation example is a tool to analyze the amount of maverick spending in a particular year. FIG. 4 is a system diagram illustrating a data flow of the analytical tool for maverick spending. To realize this tool, necessary tables and corresponding fields are identified first. The tables required are those of purchase order (410) and contract (420). The item details like item name, transaction date, item MRP, item selling price, contract number (if purchased through contract), net sales of the purchase order, etc., are extracted from a purchase order table. Item details like contract number, validity date (which denotes the expiry of the contract), supplier name, item's MRP, discounted price, etc., are picked from a contract table. These values are then joined in an attribute view 430 to generate the necessary output—i.e. the total amount spent due to maverick purchasing across suppliers for all items involved. Another attribute view could be realized in the same fashion to render the net sales across suppliers for all items which have been purchased against a valid contract.

Output of an attribute view may become an input of an analytical engine 440, which in turn provides output 450 to render the resulting data. Data rendering can be to a printout, a display, an electronic media, or to another output format. Data rendering of the predictive analysis results may include one or more of the following: displaying the results of the predictive analysis in an electronic visual display, loading the results of the predictive analysis into memory, persisting the results of the predictive analysis into physical data storage, or transmitting the results of the predictive analysis to a remote computing system.

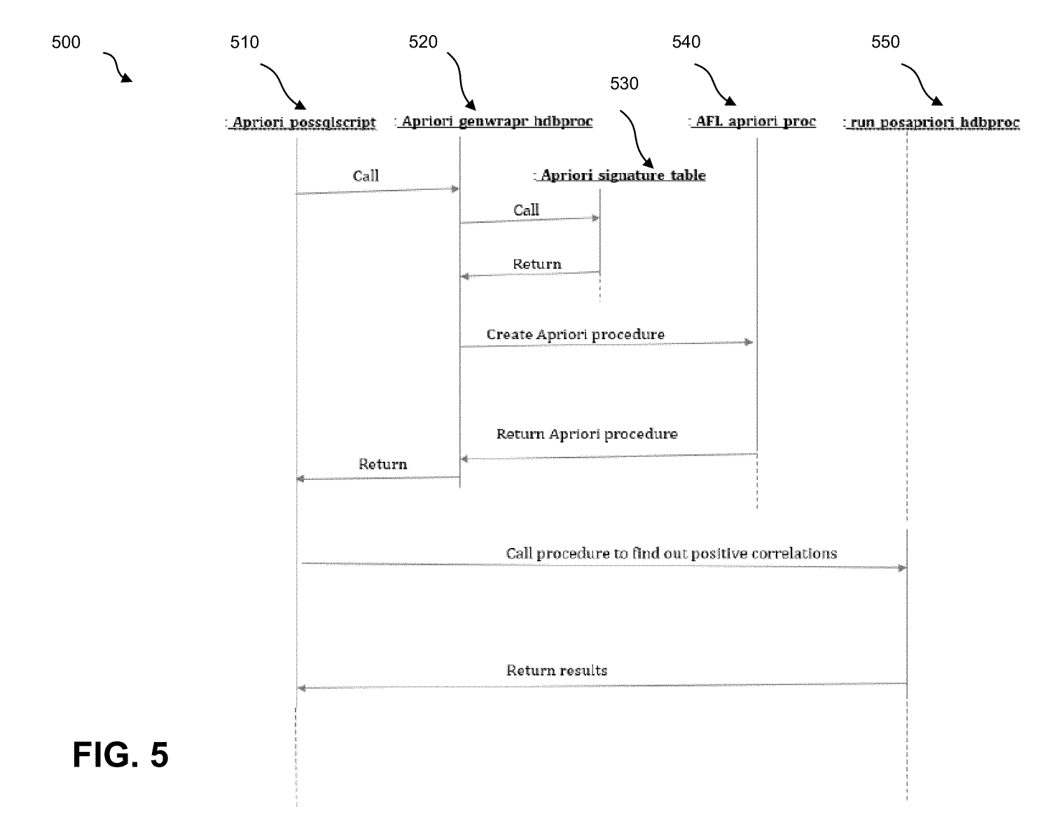

The second implementation example is a tool to analyze the positive correlation among items with higher profit margin. FIG. 5 is a system diagram illustrating a sequence diagram for positive trend analysis. A calculation view is first created (510) over the purchase order and contract tables to fetch the items that are procured at a profit (say, profit of 25% or more). A procedure (520) is written to generate a signature table (530) that contains the input and output data types required for a given case. This calculation view is passed as the input data to a signature table. This is followed by a call to an apriori algorithm, which generates a wrapper procedure (550). The apriori algorithm may be build-in in the application function library (540). Suitable calls can then be made to this apriori function by passing the default parameters for the minimum support, minimum confidence and minimum lift selected, to derive the rules. An attribute view could then be materialized on top of this to render the output result.

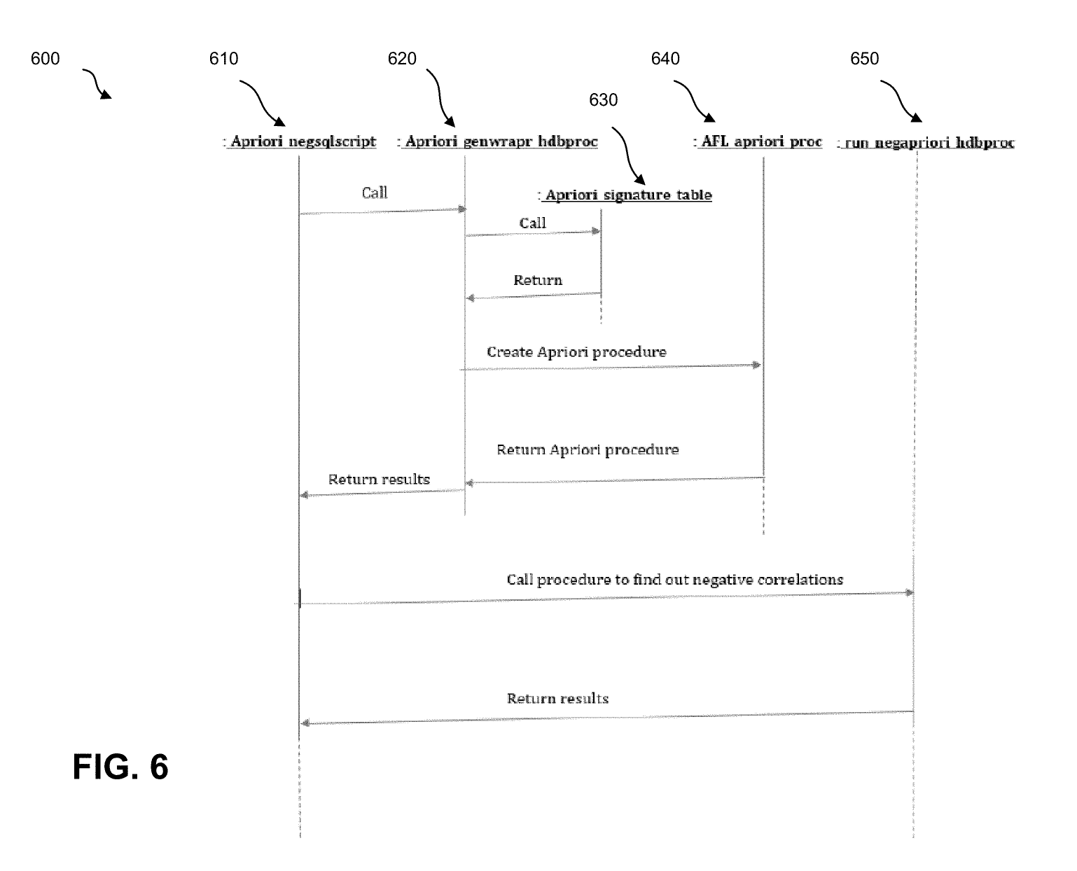

The third implementation example is a tool to analyze negative correlation among items with negative profit margin. FIG. 6 is a system diagram illustrating a sequence diagram for negative trend analysis. A calculation view is first created (610) over the purchase order and contract tables to fetch the items that are procured at a loss (i.e. zero profit margin) through maverick buying. A procedure (620) is written to generate a signature table (630) that contains the input and output data types required for our use case. This calculation view is passed as the input data to our signature table. This is followed by a call to an apriori algorithm, which generates a wrapper procedure (650). The apriori algorithm can be built-in in the application function library (640). Suitable calls are now made to this apriori function by passing the default parameters for the minimum support, minimum confidence and minimum lift we choose, to derive the rules. An attribute view could then be materialized on top of this to render the output result.

Attribute views are similar to business warehouse characteristics, dimensions or master data. Attribute views can be used for joining different dimensions or even other attribute views. They can be used to model entities and are also highly reusable in either calculation views or other analytical views.

Calculation views can be used on top of attribute views or analytical views and hence are known as composite views. Multifaceted calculations can be easily performed with calculation views which are impossible with other views such as attribute or analytical views. There are two types of calculation views: scripted and graphical views. These are differentiated based on their mode of creation. Calculation views created using the modeling tool are called graphical calculation views. Calculation views created using SQL scripts are called scripted calculation views. Calculation views can be visualized as a combination of entities, attribute views and analytical views joined together to deliver complex business logic. These views could also become a source of data to perform reporting scenarios.

Procedures are reusable units of code. These are sometimes also referred to as modules. Procedures usually have input and output parameters that can define the kind of input expected into the procedure for the logic to process and return a rationally concluded output. A procedure can provide means to set the programming language of the procedure (this is usually set to SQL script), the security modes, the default schemes to be used and the mode of execution of the procedure, i.e. sequential execution or parallel execution.

It may be possible to keep track of the expenditures incurred by the procurement department of a company in real-time, because there is no need to store data separately. The live data can be accessed as everything is in-memory in an in-memory database. This also can drastically reduce the cost of implementation and cost of maintenance. A typical modern in-memory database, such as SAP HANA, is not just a database, but a complete platform solution as it may include many provisions to push down business logic directly into the database. This is possible as many library functions are native to such a database (in other words, they are built-in).

The tool so developed is easy to use and it adds value to the organization. This application is scalable to large number of transactional data. The tool can also be customized for different organizations worldwide and for different lines of business (LOB), project teams or scrum teams.

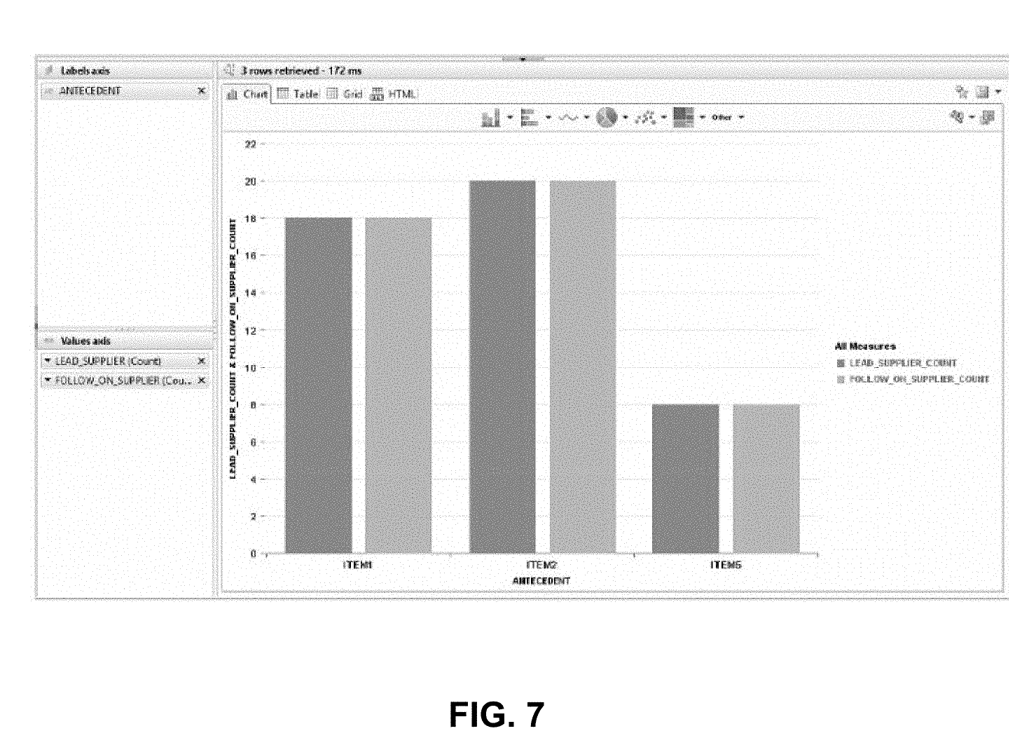

FIG. 7 is a chart illustrating lead suppliers and follow-on suppliers that exist for a particular item. This analysis could give us a general view on how many suppliers exist for a single item. In predictive analysis terminology, whenever an item (say item 1) causes the purchase of another item (say, item 2), item 1 is called the “lead item” or “antecedent” and item 2 is called “follow-on item” or “consequent.” The same applies for suppliers as well. This analysis could then help streamline the number of suppliers for a particular item.

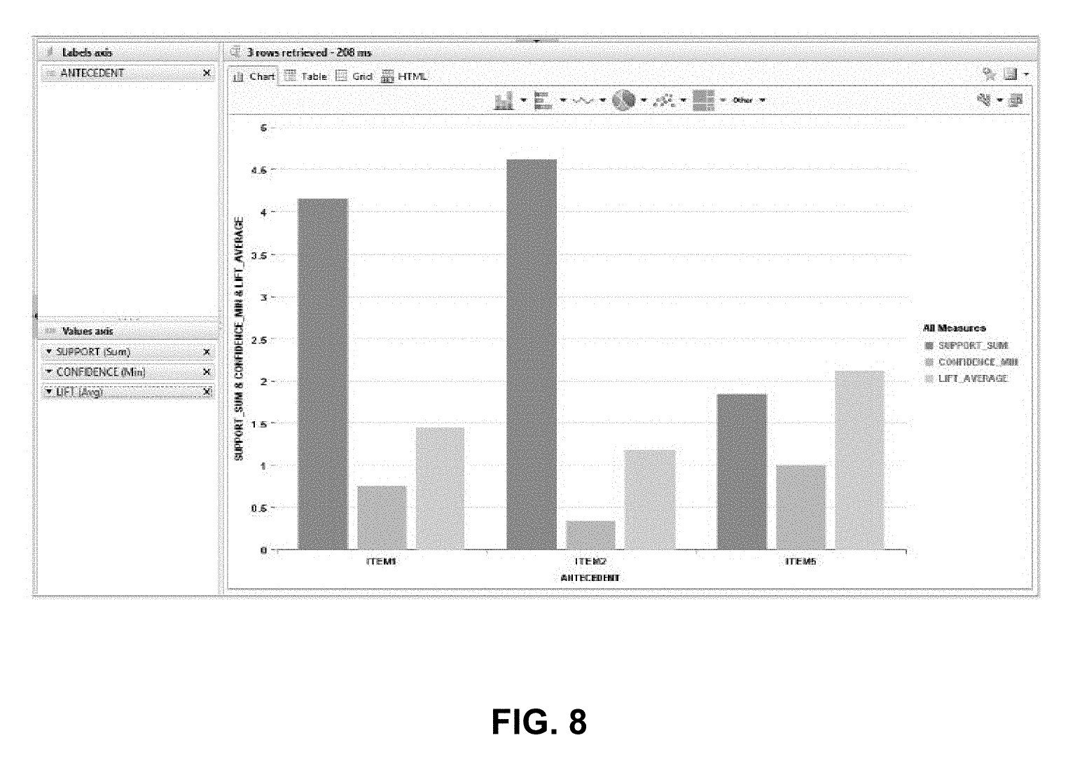

FIG. 8 is a chart illustrating support index, confidence index and average lift index. Support, confidence and lift are parameters used in predictive analysis to judge the viability of a particular item and its association with other items. Support is simply the percentage of the total number of records in the database. Confidence is the ratio of the number of transactions that include all items in the consequent, as well as the antecedent (the support) to the number of transactions that include all items in the antecedent. Lift is the ratio of confidence and support. A lift value greater than 1 indicates that the items in question, appear more often together than expected; this means that item A is positively correlated with item B. Having these ratios calculated for a particular item can help decide the appropriate values needed to pass to the apriori function in order to get realistic associations between them.

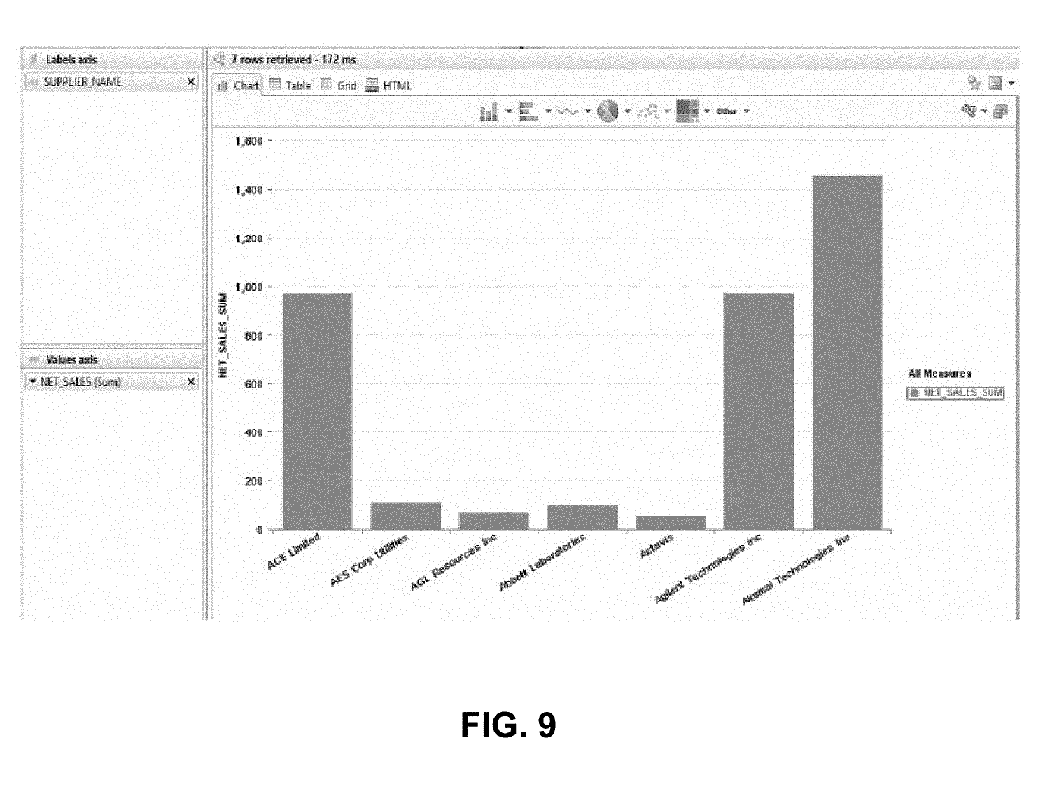

FIG. 9 is a chart illustrating net sales across various suppliers. This analytics gives a clear picture on the expenditure across different suppliers. The current solution lists the results from the BI system in a table format whereas the new solution leverages the in-memory database artifacts to render the data in user-friendly format.

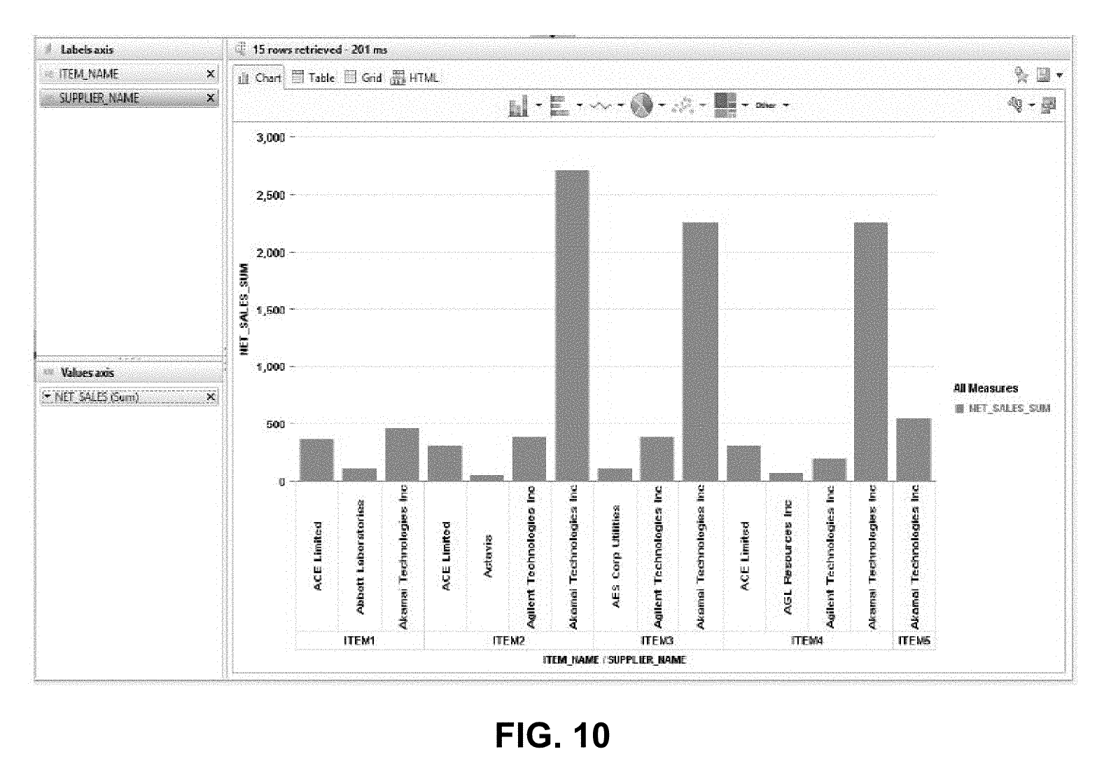

FIG. 10 is a chart illustrating net sales across various suppliers for each item present. Further drill-down of values could be introduced to the previous analysis by introducing the “item” dimension. This helps to understand the net sales per item across all suppliers with which there is an existing contract. This provides a split view which was not present earlier.

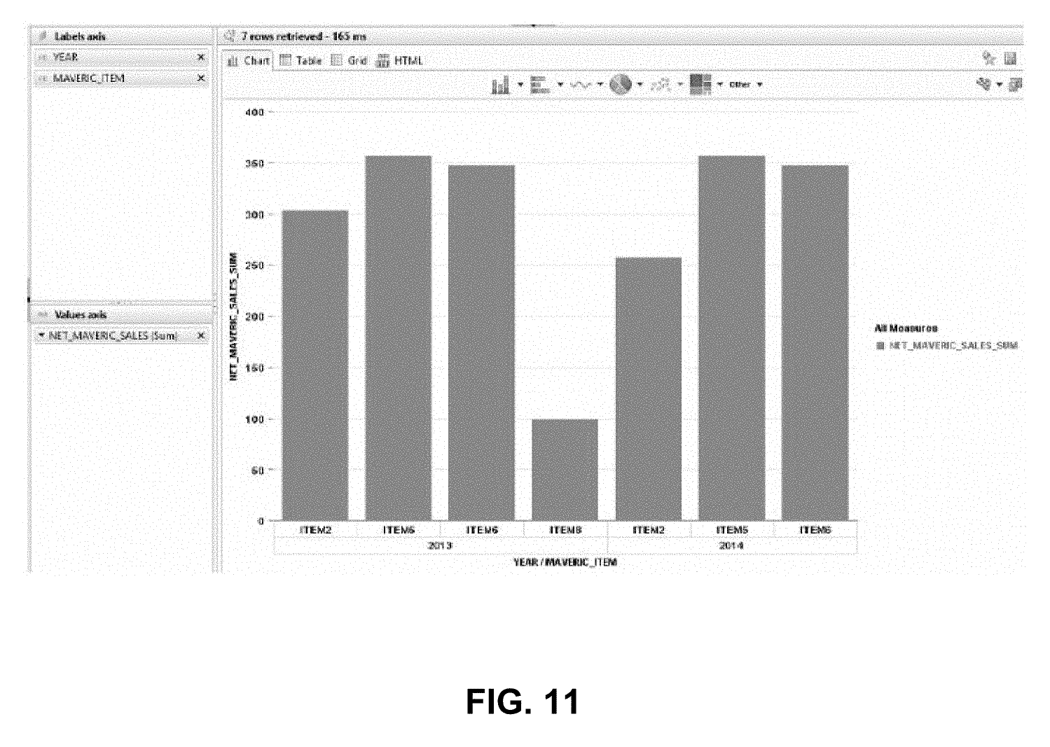

FIG. 11 is a chart illustrating net sales per maverick item bought in a year. This snapshot provides a clear picture of how each of the maverick items is adding to the company's expenditure in a particular year.

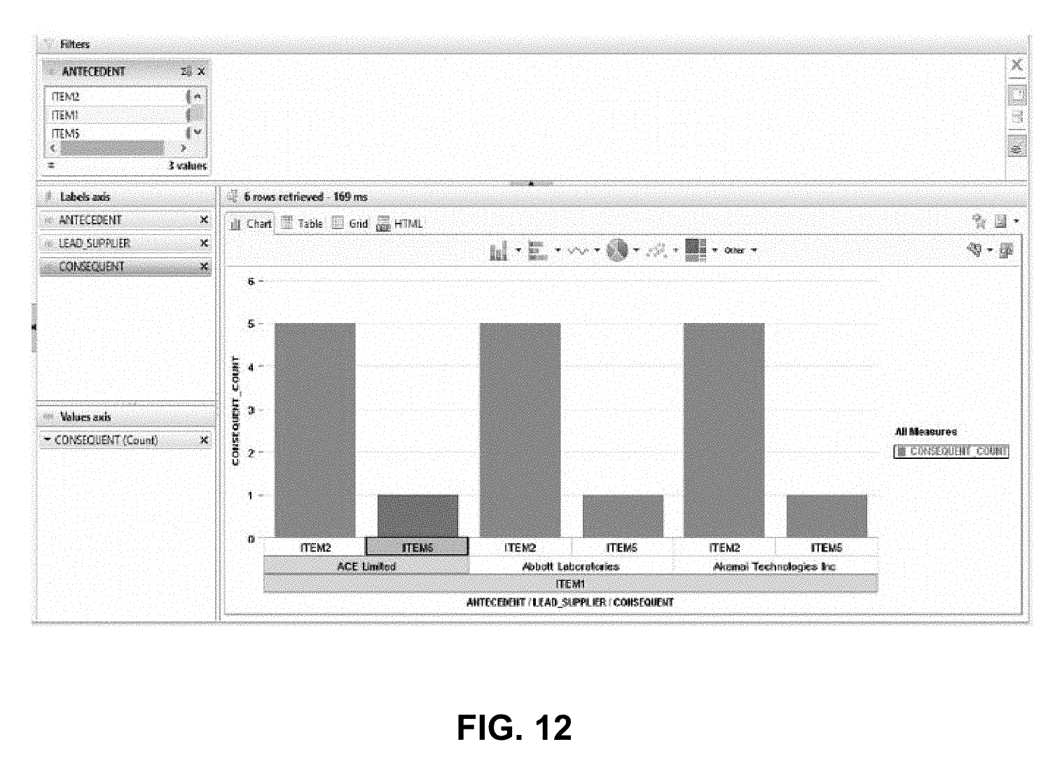

FIG. 12 is a chart illustrating count of follow on items for a particular lead item segregated by lead suppliers. This one snapshot provides an overall picture of the relationship between a lead item and its consequents. It shows, for an item, how many lead suppliers are there and the count of corresponding consequent items for each of those lead suppliers.

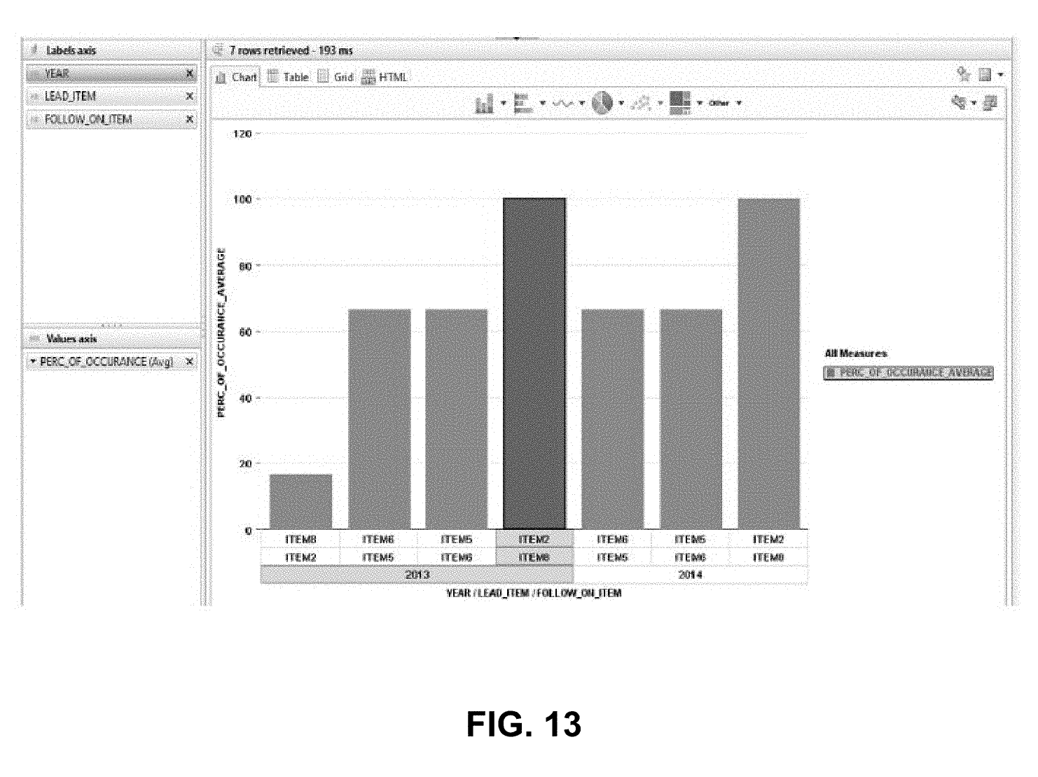

FIG. 13 is a chart illustrating rate of occurrence of correlation among maverick items across the years. This snapshot exposes the strength of correlation between items. In this prototype, the confidence value of an item set is exposed to the user as “percentage of occurrence.” This logic can be applied to both items purchased via standard procurement procedures or to maverick items. This assists in making strategic decision of signing a contract with any vendor. A contract may have a provision for an additional header discount apart from discounts at line items which suppliers usually provide. Since the probability of two items being bought together is now known, it is possible to float an RFX requesting a bid from suppliers for additional discount on this set of items rather than a different one. Thus it is now possible to obtain additional discount at the header level on set of two items apart from their individual discount at the item level.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and programmable logic devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) and/or a touchscreen by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method of predictive analysis of an attribute view of transactional data, the method implemented by one or more data processors forming part of at least one computing device and comprising:
storing transactional data of an enterprise in a relational database residing in a memory of the at least one computing device;
selecting, by the one or more data processors, a dataset from the transactional data;
generating, by the one or more data processors, a first attribute view of the dataset;
conducting a predictive analysis of the first attribute view by the one or more data processors; and
providing data comprising the results of the predictive analysis.

2. The method of claim 1, wherein the providing data comprises at least one of: displaying the results of the predictive analysis in an electronic visual display, loading the results of the predictive analysis into memory, persisting the results of the predictive analysis into physical data storage, or transmitting the results of the predictive analysis to a remote computing system.

2. The method of claim 1, wherein the transactional data comprises purchase orders and contracts.

3. The method of claim 1, wherein the dataset comprises transactions outside standard enterprise procurement processes.

4. The method of claim 3, wherein the providing data comprises rendering information by year, the information comprising expenditures for the transactions outside standard enterprise procurement processes.

5. The method of claim 3, wherein conducting the predictive analysis of the first attribute view comprises making a prediction about future transactions outside standard enterprise procurement processes.

6. The method of claim 3, wherein the transactions outside standard enterprise procurement processes comprise transactions with vendors without procurement contracts.

7. The method of claim 6, further comprising negotiating procurement contracts with vendors predicted to have future transactions outside standard procurement processes.

8. The method of claim 1, further comprising generating a second attribute view.

9. The method of claim 8, wherein the second attribute view comprises net sales across suppliers for all items purchased against valid contracts.

10. The method of claim 1, wherein the dataset comprises a group of procurement transactions representing procurement transactions made together.

11. The method of claim 10, wherein the first attribute view comprises a correlation between the procurement transactions in the group.

12. The method of claim 1, wherein the dataset comprises a purchase order table and a contracts table.

13. The method of claim 12, wherein conducting the predictive analysis comprises:
creating, by one or more data processors, a calculation view of the purchase order table and the contracts table;
generating, by one or more data processors, a signature table comprising input and output data types;
passing the calculation view as input data to the signature table;
calling an apriori algorithm from an application function library residing in the memory of the computing device;
passing default statistical parameters to the apriori algorithm;
generating a wrapper procedure by the apriori algorithm to derive rules of analysis; and
using the rules of analysis to generate the results of the predictive analysis of the correlation.

14. The method of claim 13, wherein the default statistical parameters comprise a minimum support, a minimum confidence, and a minimum lift.

15. The method of claim 14, wherein the calculation view comprises a profit margin of the procurement transactions in the group.

16. The method of claim 15, wherein the group comprises transactions with no profit.

17. The method of claim 15, wherein the group comprises transactions with profit margin above a pre-defined level.

18. The method of claim 17, wherein the pre-defined level is 25%.

19. The method of claim 1, wherein the providing data comprises rendering information for a lead item, the information comprising at least one supplier of the lead item and a number of transactions for at least one consequent item for each of the at least one supplier for the lead item.

20. The method of claim 1, wherein the providing data comprises rendering information by year, the information comprising an occurrence of at least two transactions made together.
